(19) United States
(12) Patent Application Publication
(10) Pub. No.: US 2011/0011908 A1
(43) Pub. Date: Jan. 20, 2011

(54) Quick fill adaptor for a fluid container

(76) Inventors: David W. Dietterle, Oceanside, CA (US); Jeffrey P. Smith, San Diego, CA (US)

Correspondence Address: Henry G. Kohlmann, Esq., 8402 Snowbird Drive, Huntington Beach, CA, 92646, US

(21) Appl. No.: 12/924,197

(22) Filed: Sep. 21, 2010

Related U.S. Application Data
(63) Continuation-in-part of application No. 11/897,503, filed on Aug. 30, 2007.

(30) Foreign Application Priority Data
Aug. 30, 2007 (EP) EPO 08 795 390.7
Aug. 15, 2008 (US) PCT/US08/09809

(51) Int. Cl. B62J 9/00; B62J 11/00; B65D 51/24

(52) U.S. Cl. 224/414; 220/304

(57) ABSTRACT

In a quick fill fluid container an adaptor for receiving a hollow container having a cavity or a reservoir for receiving fluids, preferable water but may be any other kind of fluids which refreshes the user or provides nourishment, reasonably necessary to refresh the user. The adaptor has a generally streamlined shape which mounts on to the container, which is typically supported in generally available cages or other mounting devices attached to a bicycle frame or other structure. A hollow extraction tube is provided for the adaptor which extends through the adaptor and into the container for withdrawal of the fluid by the user and preferably includes a mouth piece with a normally closed bite valve which is operated by the user to open the valve to extract water from the container. The adaptor has an intake port which may be disposed at many selected angles to the longitudinal axis of the adaptor base to provide a quick fill capability even while underway, The intake tube of the adaptor may be rotated to dispose the intake port to an infinite number of angles to receive the fluid dispensing apparatus such as a readily available capped water bottle or container.

### CROSS-REFERENCE TO RELATED APPLICATIONS

This application is a Continuation in Part of U.S. application Ser. No. 11/897,503 filed Aug. 30, 2007, which is incorporated herein by reference as though fully set forth. The applicants hereby claim the benefit of the referenced non-provisional U.S. Application above under 35 USC §120. Such prior application described an invention disclosed in the manner provided by the first paragraph of 35 USC §112 and is still pending. The named inventors in this application were named in such prior application.

A Patent Cooperation Treaty (PCT) application based on the U.S. application described above was filed on Aug. 15, 2008 in the U.S. Receiving office and assigned serial number PCT/U.S.08/09809 and has since expired. An initial review and opinion was issued.

A European Patent Office (EPO) application based on the PCT application set forth above was filed prior to expiration of the PCT application effective Aug. 15, 2008 as EPO 08 795 390.7 and is presently pending before the European Patent Office having a priority date of Aug. 30, 2007

### BACKGROUND OF THE INVENTION

(1) Field of the Invention

This invention relates to an adaptor for converting a typical sports bottle or other hydration container to a quick fill fluid hydration system for bicycle riding. Although described herein as a bicycle hydration system, it may be used in relation to any other conveyance and on any suitable fluid container. More specifically, this invention relates to an adaptor for a fluid container which permits rapid insertion of typical water bottles or a hose or other fluid source into the intake port, which temporarily secures the fluid source in the intake port, and unassisted rapid fill either while stationary or while underway.

(2) Description of Related Art

There are numerous examples of related art as typified by the following patents:

U.S. Pat. No. 4,386,721, issued Jun. 7, 1983 to Shimano. Shimano-1 describes a typical large water bottle holding frame with skirts on the sides to hold the water bottle in place. No dispensing apparatus is shown.

U.S. Pat. No. 4,441,638, issued Apr. 10, 1984 to Shimano. Shimano-2 describes a mounting fixture which is mounted on a bicycle frame which receives a specially designed water bottle. The bottle has a gradual increase in width as it is inserted into the mounting fixture when the width of the bottle has met the mounting fixture width, the bottle is held in place. This feature is not present in the present invention.

U.S. Pat. No. 5,024,358, issued Jun. 18, 1991 to Reichert, et al. The Reichert patent describes a bicycle mounted water bottle which includes an extraction tube or a straw to extract the water by the bicycle rider. The present application includes a tube which may be operated by the user to set an opened or closed position but is not an adaptor for permitting a quick fill for any type of container which has a cap.

U.S. Pat. No. 5,238,160, issued Aug. 24, 1993 to Faulds. Faulds describes a unique fixture bottle combination. The bottle was designed to be held in place with generally vertical gripper flanges on the sides of the mount. In addition, the opening of the bottle is sealed by a cap, which operates to close it as it is inserted into the mount and does not provide a quick fill apparatus.

U.S. Pat. No. 5,326,124, issued Jul. 5, 1994 to Allemang. The Allemang patent describes a typical water bottle. However, no streamlining quality of the bottle itself is discussed nor is any such shape shown. In addition, the Allemang patent further comprises a water pump for expelling the water, which would change the nature of the invention.

U.S. Pat. No. 5,497,920, issued May 12, 1996 to Moeller, et al. The Moeller patent describes a typical water bottle with a splash suppressing element added. In fact, different alternative implementations show that manual pour in of the fluid is required in Moeller as opposed to the quick fill of the present invention which allows the water dispensing device to be held in place by the adaptor until empty or when removed by the user.

U.S. Pat. No. 5,788,134, issued on Aug. 4, 1998 to Matic, Jr. Matic describes a water bottle which includes an access tube. The tube has a device for the rider to hold and manipulate the tube. It does not describe any sealing device in the extraction tube or elsewhere or any quick fill capability associated with the bottle.

U.S. Pat. No. 6,145,695, issued Nov. 14, 2000 to Garrigues. Garrigues describes a water bottle that is pressurized and has a straw actuated by a pull valve. No quick fill system is possible with a pressurized system. In addition, a pull valve is also required because the pressure in the system requires a very positive pressure resistant closure.

U.S. Pat. No. 6,401,997, issued Jun. 11, 2002 to Smerdon, Jr. Smerdon describes a collapsible water bottle with a dispensing straw. The bottle included a leak control valve mounted in the side of the bottle to prevent loss of fluid in the event the straw was removed. Smerdon does not describe any quick fill capability.

U.S. Pat. No. 7,204,382, issued Apr. 17, 2007 to Cezeaux. Cezeaux describes a standard water bottle that includes a bite valve in the extraction tube operable by the user to extract fluid from the bottle. Cezeaux does not describe any quick fill capability.

None of the related inventions teach a structure, which includes a quick fill capability or splash suppression. In particular, no angled fill capability is described as set forth in the present invention. The present invention satisfies the need for a rapid fill of the fluid container, when the fluid dispensing apparatus is inserted into the adaptor, while the rider focuses on operation of the bicycle.

### BRIEF SUMMARY OF INVENTION

The present invention comprises a quick fill adaptor for a hollow fluid container including bicycle mounted bottles having a cavity or a reservoir for receiving fluids, such as water, but may be any other kind of fluids which refreshes the user or provides nourishment, reasonably necessary to refresh the user. The quick fill adaptor may be used in place of the original bicycle bottle cap affixed to bottles used for carrying water usually through mating screw threads, snap on fasteners or other fastening structure and typically has a hole for a straw or extraction tube. Such original bottle caps have no quick fill capability as is provided in the present invention.

In operation the adaptor of the present invention is attached to a sports bottle or other type of hydration container, which is mounted to a bicycle frame, the handle bars 2b, aerodynamic bars 21 or other parts of the structure using a bracket 22 as shown in FIG. 11 or other mounting structure as is known in the art.

The adaptor of the current invention is described in two embodiments. One embodiment is for mounting on an angled or generally vertical frame member of the bicycle and the other is for mounting in between the aerodynamic bar type handle bars or other generally horizontal surface of the bicycle as the case may be.

In either embodiment the adaptor on the bottle has an intake port which is disposed at an angle to the longitudinal axis of the adaptor to provide a quick fill capability.

The quick fill adaptor fitted to a bottle mounted on the angled or generally vertical frame member or down tube is disposed at angles greater than 90 degrees to the longitudinal axis of the adaptor body preferably 160 degrees but other angles are suitable depending on the angle of the frame member or down tube and the inclination of the user. The intake port of the adaptor on the bottle mounted on the aerodynamic bars or other horizontally disposed structure is generally mounted near or at 90 degrees to the adaptor body.

The adaptor of the present invention includes a hole for receiving a grommet which receives a hollow straw or extraction tube in the front of the adaptor which extends into the bottle to its maximum extent near the intake port so the user can access the bottle contents. The extraction tube often includes a normally closed bite valve which is operated by the user to open the valve to extract water from the bottle through the adaptor.

### BRIEF DESCRIPTION OF THE SEVERAL VIEWS OF THE DRAWING

FIG. 1 is a view of a first embodiment of a generally vertically disposed adaptor on a bottle mounted on the generally vertical section of the frame of a bicycle such as the up tube or other non horizontal section of the bicycle 2. The adaptor 1a is mounted with the intake tube of the adaptor positioned at an angle to the longitudinal axis of the adaptor base and the extraction tube positioned for use by the user.

FIG. 2 is a perspective view of the generally vertically disposed adaptor from the back and left side of the adaptor.

FIG. 3 is a perspective view of the generally vertically disposed adaptor mounted on a sports bottle showing the adaptor cap and anti-splash resistant gasket.

FIG. 4 is an exploded view of the adaptor showing a funnel, splash resistant gasket and the adaptor cap which secures the gasket and funnel in the intake port. Also a grommet which fits into the face of the adaptor is shown and the sports bottle is spaced apart from the adaptor.

FIG. 4A is a detailed view of the funnel.

FIG. 5 is a view of the right side of the generally vertically disposed adaptor showing the intake tube at an angle to the longitudinal axis of the adaptor body.

FIG. 6 is a view of the left side of the generally vertically disposed adaptor showing the angularly disposed intake tube.

FIG. 10 is a view of the generally vertically disposed adaptor from the bottom.

FIG. 11 is a view of a second embodiment of the generally horizontally disposed adaptor on a bottle mounted on the arrow bars or handle bars portion of a bicycle, not shown, with the intake port positioned at an or near 90 degrees to the longitudinal axis of the adaptor base and the extraction tube positioned for use by the user.

FIG. 12 is a perspective view of the generally horizontally disposed adaptor from the back and left side of the adaptor.

FIG. 13 is a perspective view of the generally horizontally disposed adaptor mounted on a sports bottle showing the cap and gasket in operating position.

FIG. 14 is an exploded view of the generally horizontally disposed adaptor with the sports bottle disconnected from the adaptor with the cap, gasket and funnel exploded from the intake port.

FIG. 14A is a perspective view of the funnel of the generally horizontally disposed adaptor showing the ridge, body and the chamber at the base of the funnel having several openings on one side and with a baffle clearly visible on the other.

FIG. 14B is a second perspective view of the funnel of the generally horizontally disposed adaptor showing the ridge, body and the chamber at the base of the funnel having several openings on one side and a baffle on the other.

FIG. 15 is a view of the right side of the generally horizontally disposed adaptor showing the angularly disposed intake tube near or at 90 degrees to the longitudinal axis of the adaptor and the raised front section.

FIG. 16 is a view of the left side of the generally horizontally disposed adaptor showing the angularly disposed intake tube and the raised front section.

FIG. 17 is a view of the front of the generally horizontally disposed adaptor showing the hole for the grommet and the raised front.

FIG. 18 is a view of the back of the generally horizontally disposed adaptor showing internal portion of the adaptor.

FIG. 19 is a view of the generally horizontally disposed adaptor from the top down looking into the inside of the adaptor cavity and showing the flat section of the rise from the inside.

FIG. 20 is a view of the generally horizontally disposed adaptor from the bottom.

### DETAILED DESCRIPTION OF THE INVENTION

There are two specific embodiments of the invention described herein. While the specific embodiments are described, it is not intended that the scope of this invention be limited to such embodiments but it is intended that the scope shall be as broad as the claims will allow.\

In bicycle endurance contests and other events, it is necessary for riders to maintain hydration. This is accomplished by each rider carrying sufficient fluid to provide such hydration or by being provided with fluid along the route.

Spectators, pit crews and others often provide bottles of water to the riders or spray them with water from hoses as they pass by. The present invention provides a way of providing fluid which can be replenished by insertion of a fluid dispensing apparatus such as a bottle or hose by insertion direct into an adaptor and left in position as the rider passes by but which can easily be removed by the rider after the bottle is empty or the hose reaches its maximum extent and pulls out.

### First Embodiment

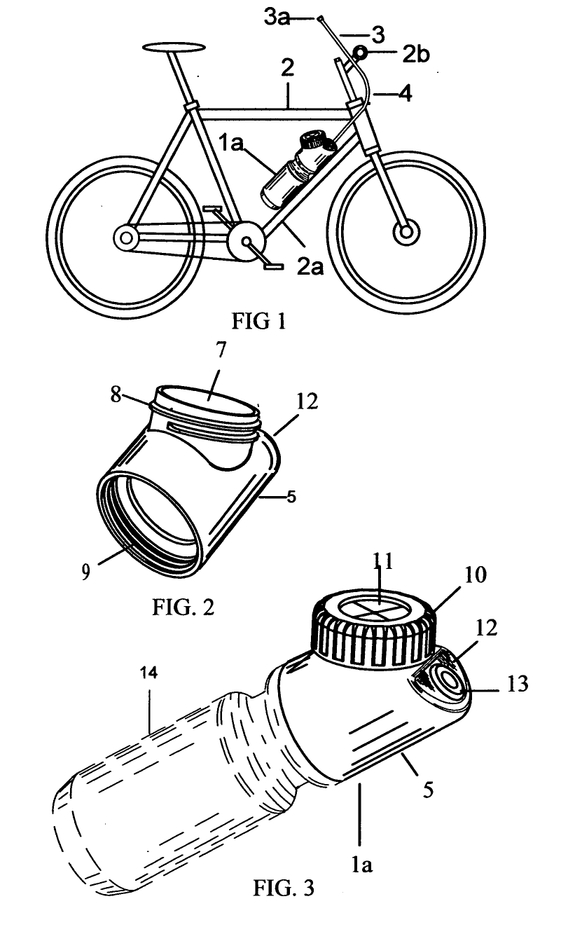

Referring to the figures, FIG. 1 and FIG. 3 a first embodiment of a generally vertically disposed adaptor 1a is mounted on a sports bottle 14 or other container, and comprises an intake tube 6 mounted at an angle on an adaptor body 5 and disposed toward the front of the body 5. Adaptor 1a includes a cap 10 and a gasket 11 held in place by the cap 10. A grommet 13 for receiving an extraction tube 3 is mounted in a front flat surface 12.

As shown in FIG. 1, an extraction tube 3 is received in the grommet 13 and is generally flexible to permit ease of insertion. The extraction tube 3 extends through the adaptor 1a to the lowest part of the cavity of the sports bottle or fluid container 14. The extraction tube 3 may be sufficiently rigid to maintain its shape without support, and include a flexible bend 4 in the tube or may optionally be flexible. In addition, the extraction tube structure 3 itself may be fabricated to be manually positioned anywhere along its length or attached to the handle bars 2b so that it can be bent into any position or direction and maintain that position.

This may be accomplished by providing a bendable wire in the tube as is known in the art or within a bendable structure adjacent the wall of the tube itself which receives the extraction tube 3.

Further FIG. 1 shows a bite valve 3a at the top of the extraction tube 3, which permits the user to open the bite valve 3a with his or her teeth and retrieve the fluid in the container 1a. The bite valve 3a prevents the fluid from returning down the tube and into the sports bottle or container 14 after use allowing the extraction tube 3 to retain fluid along its length. This permits extraction of fluid as needed by the rider without the need to draw the fluid up the entire length of the extraction tube 3 each time it is used.

FIG. 2 shows a perspective of the adaptor 1a without a cap 10 showing screw threads on intake tube 6 for mating with the cap 10. The intake tube 6 is attached to or integral with the body 5. The body 5 is a generally curved hollow container, which has screw threads for mating to a sports bottle or fluid container 14 (not shown).

Further in FIG. 2 and FIG. 3, the intake tube 6 has an intake port 7 which communicates with the interior of adaptor 1a. Further intake tube 6 is positioned to angle to the longitudinal axis of the adaptor body and disposed toward the front of the adaptor 1a preferably at 160 degrees from the general longitudinal axis of the body 5 although any other suitable angle may be used that does not cause the fluid source to fall out of the intake port.

While water is described as the fluid to be received by the adaptor 1a, other fluids such as juice or appropriate sports hydration drinks or any other fluid, which refreshes the user or provides nourishment or refreshment reasonably necessary for the user, is to be included within the scope of this invention.

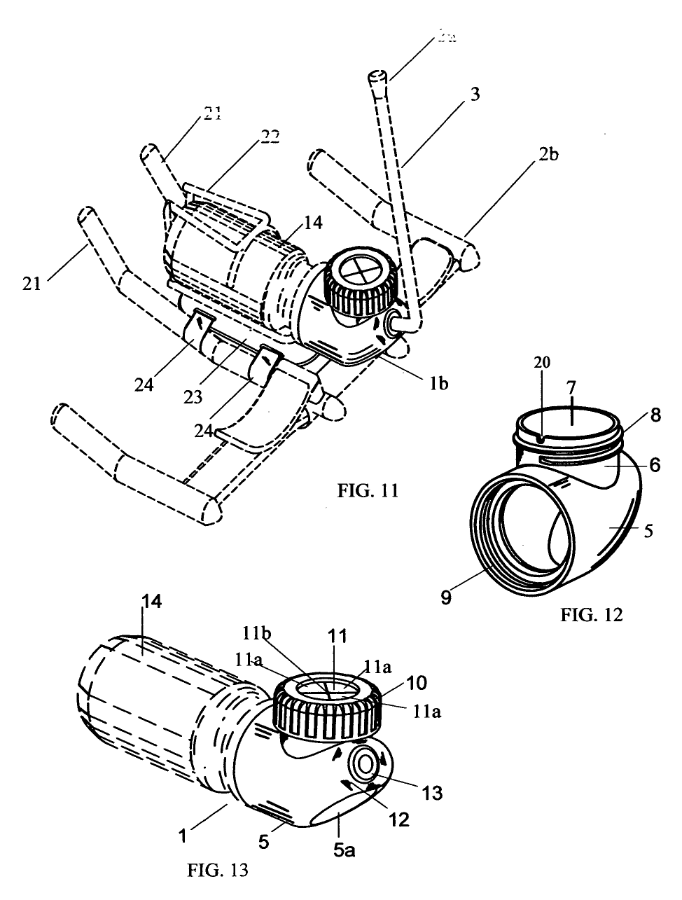

Since the adaptor 1a is intended to be affixed to sports bottles or other existing containers 14, the container 14 on which the adaptor is mounted may be rotated in either direction within the bracket 22 as shown in FIG. 11 or other mounting structure to position the intake tube 6 of the adaptor 1a to a suitable position as determined by the user. Such positioning is accomplished with respect to circular shaped containers 14 by simply rotating the container within the bracket 22 as shown in FIG. 11 or other mounting structure and tightening the mechanism to hold the sports bottle 14 or the adaptor fast where the container is not circular in shape such as a square or other geometric cross section. The bracket 22 as shown in FIG. 11 or other mounting structure may be mounted on the side of the bicycle mounting frame 2a at the angle desired and the container secured in the mounting structure.

As shown in FIG. 3, the front lower portion of the adaptor 1a includes a curved body 5 section, a front flat section 12, and the upper intake tube 6 forms a cavity in the adaptor 1a.

As shown in FIG. 2, the rear of adaptor 1a has female screw threads 9 for receiving the sports bottle or container 14 in place of the container 14 cap, if any. Most water and other fluid containers have threaded caps so they may be secured sufficiently to prevent leakage. The female screw threads 9 are preferred, however, any other fastening system, which prevents leakage, may also be used.

Typical sports bottles, containers 14 or other hydration systems are often mounted on bicycles in a generally vertical direction along one of the bicycle frame members, such as bicycle up tubes. These devices are not easily accessible while underway because they are generally positioned under another structural member such as frame member 2. In the present invention the adaptor 1a when mounted on the container 14 may be positioned to deviate from the vertical to make the intake tube 6 of adaptor 1a to make intake port 7 more accessible from either side of the bicycle dependent on the position desired.

Further, the present invention provides a structure which permits insertion of bottles containing fluid, hoses for delivering fluid or other fluid dispensing apparatus into an intake tube 6 disposed to one side or the other of the vertical axis of the bicycle and facilitates rapid insertion of fluid dispensing apparatus, into the quick fill intake tube 6 of adaptor 1a and easy removal of the fluid dispensing apparatus, when filling is completed, while underway.

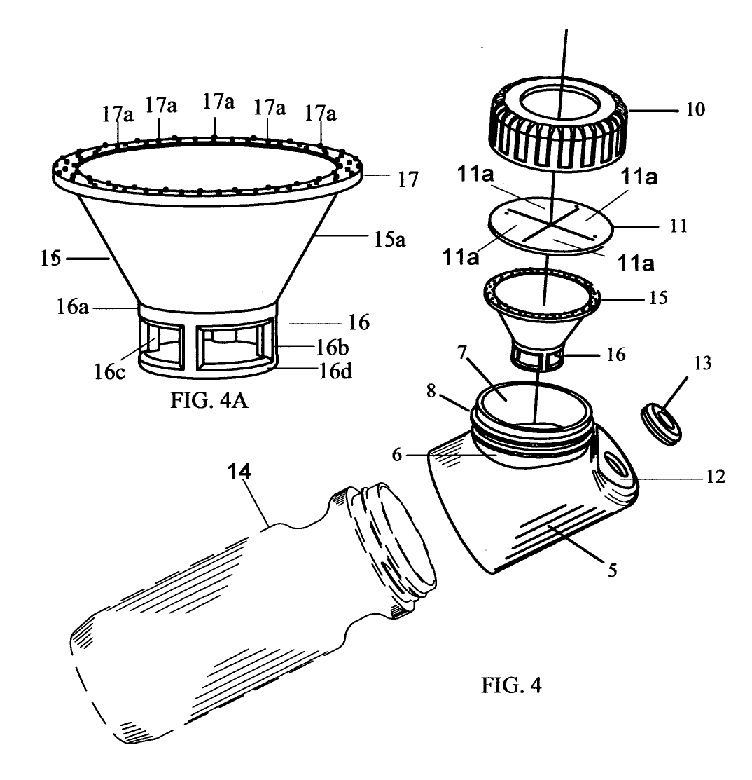

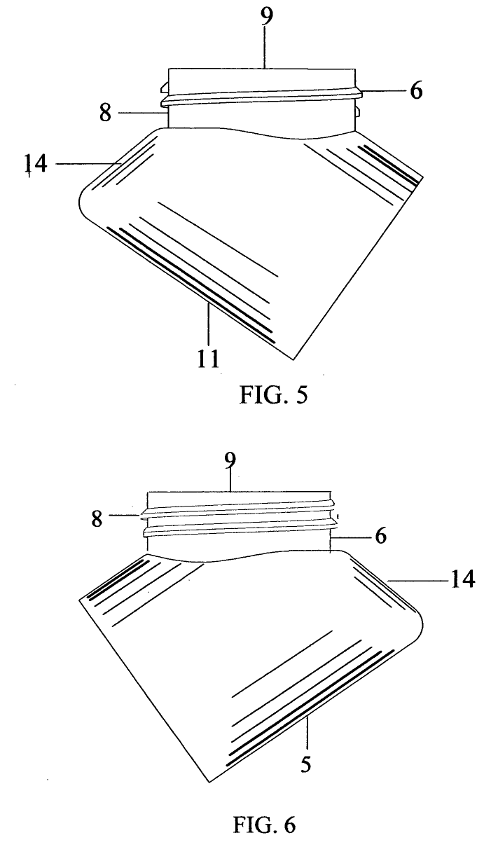

The perspective view in FIG. 3 shows the intake tube 6 disposed at an angle to and along the longitudinal axis of the base of the adaptor 1a. The angle permits the intake tube 6 to retain the fluid dispensing apparatus such as water bottles, hoses or other fluid providing apparatus within the intake tube 6 when it is rotated or otherwise positioned to receive the fluid dispensing apparatus without interfering with the bicycle frame members including specifically frame member 2. Also shown is the gasket 11. This gasket 11 has a plurality of flexible flanges 11a as shown in FIG. 4A when the flanges 11a separate on insertion of a water bottle or other fluid dispensing apparatus and bias against the surface of the water bottle or other fluid source to improve the insertion and releasable retention of the fluid dispensing apparatus within the intake tube 6 as well as avoiding other parts of the bicycle while underway.

The angle of the intake tube 6 of adaptor 1a relative to the general longitudinal axis of the adaptor body 5 may be varied as required for the particular application. Generally, the adaptor 1a intake tube 6 should be disposed generally vertical when mounted to the angled bicycle frame members before rotation to the desired access and insertion position as described above. Preferably, the intake tube 6 is disposed to an angle of about 160 degrees from the longitudinal axis of the adaptor 1a body with the top of the intake tube 6 disposed toward the front of the adaptor, however, this invention is not restricted to any specific angle.

Referring to FIG. 4, an exploded view of the adaptor 1a is shown with intake tube 6 having a number of screw threads 8 around the circumference thereof for receiving a cap 10. The intake port 9 of intake tube 6 receives a funnel 15 having an annular ridge 17, a funnel body 15a, and a chamber 16. The annular ridge 17 prevents the funnel 15 from falling through the intake port 7 of the intake tube 6. The annular ridge 17 of funnel 15 also receives a gasket 11, which includes a plurality of flexible flanges 11a, which are disposed radially along the surface of gasket 11. When a fluid dispensing apparatus is inserted into the funnel 15, the funnel 15 acts as a guide for the dispensing apparatus into the intake port 8 or intake tube 6 of the adaptor 1a and flanges 11a on gasket 11 assist in releaseably holding the fluid dispensing bottle, hose or other dispensing apparatus in the funnel 15 and minimize splashing. The gasket 11 further includes a hole 11b in the center thereof to provide a gripping action or bias on the fluid dispensing apparatus while it is inserted in the funnel 15. An adaptor cap 10 includes internal screw threads (not shown) to engage the screw threads 8 on the intake tube 6 and holds the gasket 11 and the funnel 15 in place on the intake tube 6.

FIG. 4A shows detail of the funnel 15. The annular ridge 17 is at the top thereof. The funnel 15 includes a plurality of small fingers 17a, which secure the gasket 11 to the funnel 15 when the cap 10 is attached. The body 15a of the funnel 15 connects the annular ridge 17 and a chamber 16 forming a general funnel shape.

The chamber 16 of the funnel 15 is provided with a plurality of openings to permit fluid to enter the body 5 of adaptor 1a. The openings are formed by a plurality of struts 16b. The struts 16b are disposed to guide the fluid delivery device into position within the funnel 15 and each strut 16b has a flexible engaging section 16c disposed inwardly from each strut 16b. Engaging sections 16c have sufficient resilience to provide a gripping action, which assists in the temporary retention of the fluid delivery devices within the funnel 15. The struts 16b are mounted around the periphery of an annular ring 16a attached to or integral with the bottom of the body 15a of funnel 15 opposite the annular ridge 17. The opposite ends of struts 16b are attached to a circular section 16d. The annular ring 36d, circular section 16d and the struts 36a may be mounted in separately in a structure or made integral with the funnel 15. While a circular section 16d has been shown in the preferred embodiment, it may alternatively be an annular ring similar to annular ring 16a to form a hole in the bottom of chamber 16.

As discussed above, gasket 11 as shown in FIG. 4 has a plurality of flanges 11a directed radially inward along the surface of the gasket 11. The flanges 11a are to be of sufficient stiffness to bias against the sides of fluid dispensing apparatus such as bottles and hoses when inserted and sufficiently resilient to permit removal of such fluid dispensing apparatus but also sufficiently stiff to minimize splashing. As shown in FIG. 4 flanges 11a have a generally triangular shape and are disposed radially on the splash gasket 11 to form a hole 11b at the center of the splash gasket 11. The general size of the hole 11b is smaller than the diameter or width of the device being inserted. The flanges 11a provide resistance to removal of the water bottle or hose until a sufficient amount of fluid has been introduced and the water bottle or hose is removed.

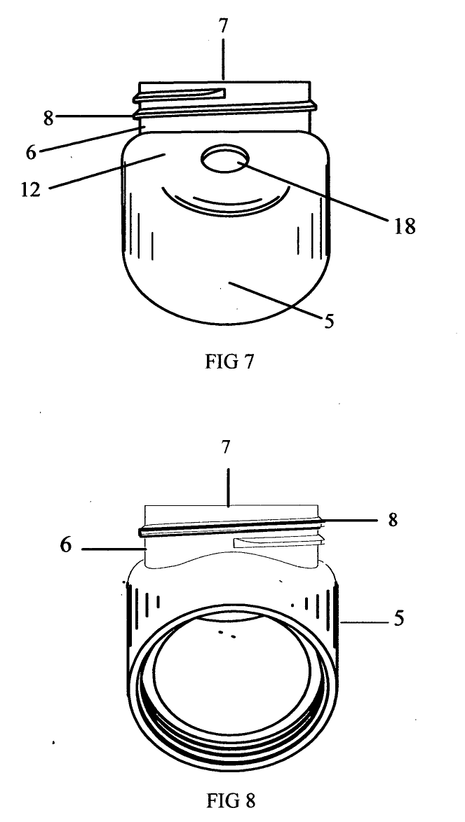

FIG. 5 and FIG. 6 show the first embodiment of the adaptor 1a from the right side and the left side respectively, which illustrates the angled nature of the resistance to removal of the water bottle or hose until a sufficient amount of fluid has been introduced and the water bottle or hose is removed.

FIG. 5 and FIG. 6 show the first embodiment of the adaptor 1a from the right side and the left side respectively, which illustrates the angled nature of the generally vertically disposed adaptor 1a and its orientation relative to the vertical axis of a bicycle when mounted on the bicycle up tube.

FIG. 7 and FIG. 8 show the first embodiment of the adaptor 1a from the front and back, respectively. FIG. 7 shows the grommet hole 13a for the grommet 13. Also shown is a generally flat surface 12 surrounding the hole 13a. FIG. 8 shows the adaptor 1a illustrating the screw threads 9 and the internal cavity of the adaptor 1a.

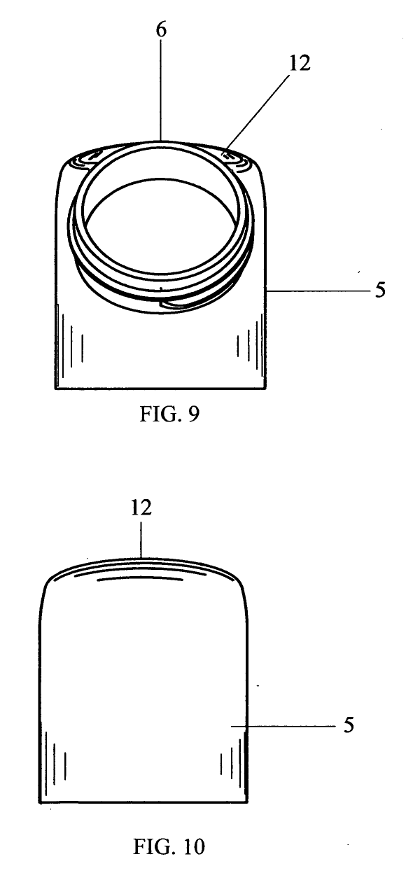

FIG. 9 and FIG. 10 show the adaptor 1a from the top and bottom, respectively. FIG. 9 illustrates the angle of the intake tube 6 of the adaptor 1a relative to the body 5 of the adaptor 1a and the screw threads 8 thereon.

FIG. 10 shows the curved nature of the front of adaptor 1a.

### Second Embodiment

FIG. 11 shows a second embodiment. The adaptor 1b, is mounted on a generally horizontal platform 23 attached by hook and catch straps 24 to bicycle handle bars, aerodynamic bars or other horizontal structure. The adaptor 1b has an intake tube 6 structure attached to or integral with the base 5 of the adaptor 1b at an angle approximately 90 degrees to the longitudinal axis of the base 5 of the adaptor 1b. In use the adaptor 1b will typically be facing backwards on the bicycle and thus has a flat plate 5a in the front thereof to position the grommet 13 and thus the extraction tube 3 to be where the rider of the bicycle can easily access it. In all other respects the apparatus contained in the intake tube 6 of adaptor 1b is identical to the apparatus contained in the intake tube 6 of the adaptor 1a.

This second embodiment of adaptor 1b is intended to permit generally horizontal positioning of the longitudinal axis of the base 5 of adaptor 1b on the aerodynamic bars or handlebars of the bicycle. Rotation of the adaptor 1b, if desired, is then as described above for adaptor 1a.

Referring to the figures, FIG. 11 and FIG. 13 the second embodiment of a generally horizontal disposed adaptor 1b is mounted on a sports bottle 14 or other container, and includes an intake tube 6 mounted at an angle on an adaptor body 5. Adaptor 1b includes a cap 10 and a gasket 11 held in place by the cap 10. A grommet 13 for receiving an extraction tube 3 is mounted in a hole I in a front raised surface 12 above a flat surface 5a.

Referring to FIG. 12 which shows a perspective view of the adaptor 1b having a hollow body 5 and female threads 9 on the inside for receiving a sports bottle or other hydration container 14 and an intake tube 6 with external threads for receiving a cap 10. However, the intake tube 6 of the adaptor 1b is placed at or near 90 degrees to the longitudinal axis of the body 5 of the adaptor 1b and may be attached or made integral with body 5. 19 on one side into the notch 20 of the intake tube 6. The annular ridge 17 prevents the funnel 15 from falling through the intake port 7 of the intake tube 6 and the tab 19, which fits into a corresponding notch 20 in the intake tube 6 stabilize the funnel 15 when the cap 10 is fastened to the adaptor intake tube 6. The annular ridge 17 of funnel 15 also receives a gasket 11, as in the first embodiment, which includes a plurality of flexible flanges 11a, disposed radially along the surface of gasket 11. When a fluid dispensing apparatus is inserted into the funnel 15, the funnel 15 acts as a guide for the dispensing apparatus into the intake port 8 or intake tube 6 of the adaptor 1b and flanges 11a on gasket 11 assist in releaseably holding the fluid dispensing bottle, hose or other dispensing apparatus in the funnel 15 and minimize splashing. The gasket 11 further includes a hole 11b in the center thereof to provide a gripping action or bias on the fluid dispensing apparatus while it is inserted in the funnel 15. An adaptor cap 10 includes internal screw threads (not shown) to engage the screw threads 8 on the intake tube 6 and holds the gasket 11 and the funnel 15 in place on the intake tube 6.

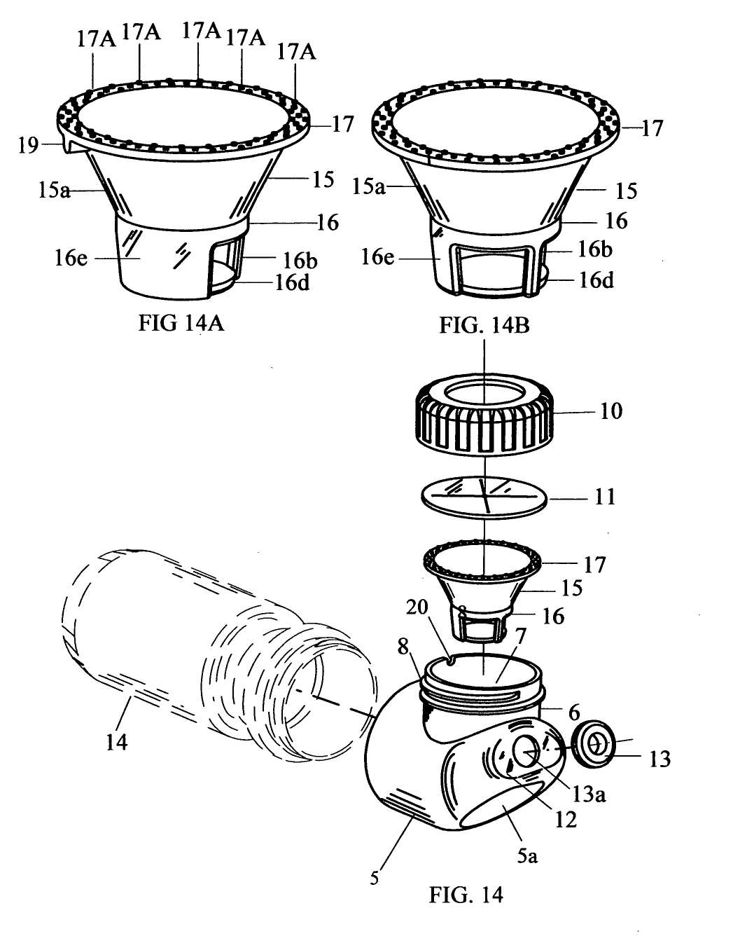

The funnel 15 of FIG. 14A and FIG. 14B are identical with each other and similar to the funnel 15 in FIG. 4. The funnel 15 of FIG. 14A and FIG. 14B are identical except that one is rotated to a different view to show the change in the chamber 16 and the addition of the tab 19 between the funnel 15 of adaptor 1a as shown in FIG. 4, which has no tab. The chamber 16 of the funnel 15 of the second embodiment as shown in FIG. 14A and FIG. 14B has a plurality of struts to form openings. However, a wall or baffle is provided which closes off some of the openings of the chamber 16 disposed toward the sports bottle or container 14 to increase splash resistance in the adaptor 1b. This position is maintained by having the funnel tab 19 being placed in the intake port notch 20 and secured when the cap and gasket are in place.

FIG. 4A shows detail of the funnel 15 of the second embodiment. The annular ridge 17 is at the top thereof. The funnel 15 includes a plurality of small fingers 17a that secure the gasket 11 to the funnel 15 when the cap 10 is attached. The body 15a of the funnel 15 connects the annular ridge 17 and a chamber 16 forming a general funnel shape. A tap 19 is added to the annular ridge on one side of the annular ridge 17. This tab 19 mates with a notch 20 in the intake tube 6 to maintain the position of the funnel 15 in the intake tube 6.

The chamber 16 of the funnel 15 is provided with a plurality of openings to permit fluid to enter the body 5 of adaptor 1b. The openings are formed by a plurality of struts 16b as with the first embodiment of the adaptor 1a. The struts 16b and a baffle 16e are disposed to guide the fluid delivery device into position within the funnel 15 and each strut 16b has a flexible engaging section 16c disposed inwardly from each strut 16b. Engaging sections 16c have sufficient resilience to provide a gripping action that assists in the temporary retention of the fluid delivery devices within the funnel 15. The struts 16b are mounted around a portion of the periphery of an annular ring 16a attached to or integral with the bottom of the body 15a of funnel 15 opposite the annular ridge 17. The opposite ends of struts 16b are attached to a circular section 16d. The annular ring 16e, circular section 16d and the struts 16e may be mounted separately in a structure or made integral with the funnel 15.

In this embodiment the baffle 16e preferable closes approximately one half of the area of the chamber 16 opposite the location of the notch to assist in splash control due to the horizontal nature of the adaptor 1b and the sports bottle or container 14. More or less closure of the chamber 16 may be required depending on terrain or roughness of the road traveled as may be required. Size of the baffle 16e is therefore variable dependent on conditions and this invention is not to be restricted to one half of the chamber 16.

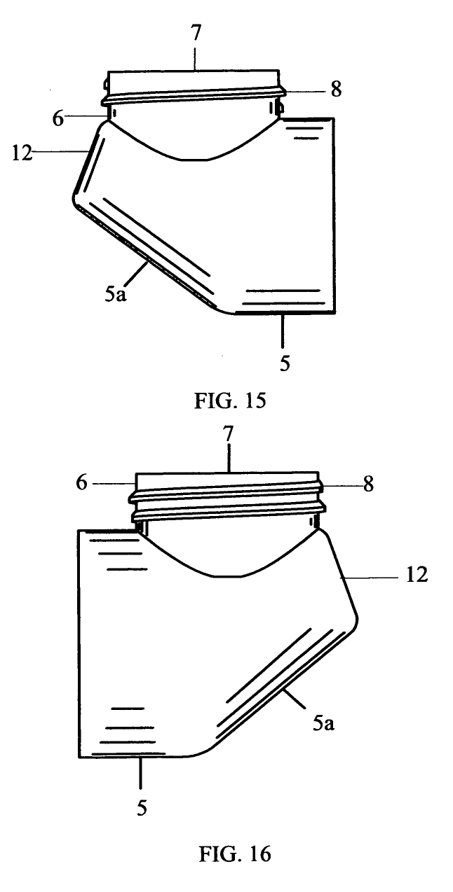

Referring to FIG. 15 and FIG. 16 the right and left sides of the adaptor illustrate the 90 degree or so position of the intake tube 6 relative to the body 5 of the adaptor 1b. In addition, FIG. 15 and FIG. 16 also show the rise of the angled section 5a which raises the location of the grommet 13 and thus the location of the extraction tube 3,

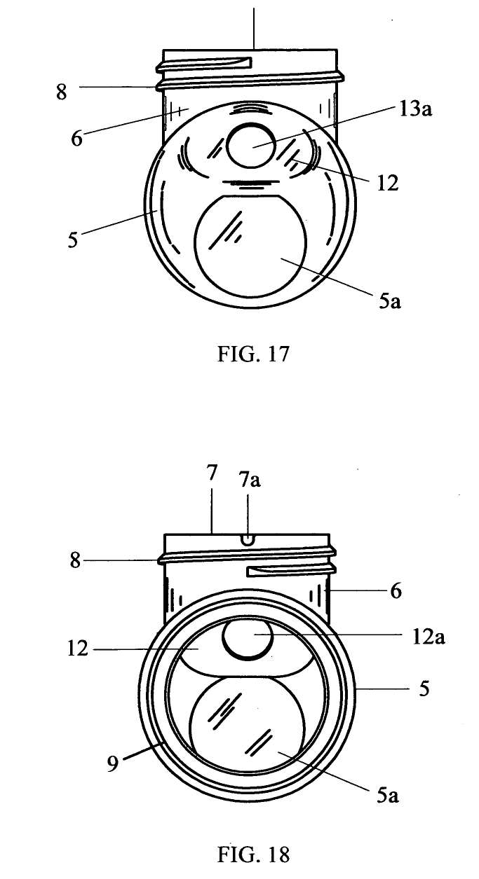

Referring to FIG. 17, the front of the adapter 1b grommet hole 13a and the surrounding flat surface 12 is shown raised above the flat section 5a although this could also be a curved section or other geometry.

Referring to FIG. 18, the grommet hole, surface 5a and flat surface 12 is shown through the back of adaptor 1b. The screw threads 9 on the inside of the adaptor 1b and the screw threads 9 on the intake tube 6 can be seen.

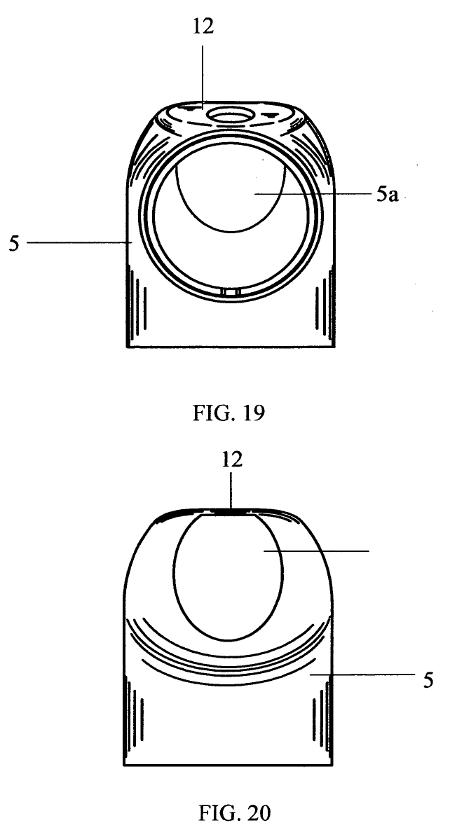

FIG. 19 and FIG. 20 show the top and bottom of the adaptor 1b. The raised section 5a can be seen in both views. Section 12 can only be seen in FIG. 19.

Other Variations and modifications of the above described invention will be apparent to those skilled in the art of manufacturing fluid bottles and the like. Such variations in bottle shape, intake and extraction apparatus and multiple fluids which may be used are to be included within the scope of this invention.

Having thus described the invention what is claimed is:

1. An apparatus for receiving fluid comprising:
a. a base having at least one opening for receiving at least one container;
b. at least one intake port supported by said base at an angle from the longitudinal axis of said base for receiving a fluid dispensing apparatus communicating with said at least one cavity of said container, and
c. at least one extraction tube for removing the contents of said container.

2. An apparatus as described in claim 1 having an open end communicating with said intake port through said base.

3. The apparatus of claim 1 wherein the angular disposition of the longitudinal axis of said at least one intake port to the general longitudinal axis of the base is greater than 90 degrees near the at least one opening for receiving said at least one container.

4. The apparatus of claim 1 wherein the angular disposition of the longitudinal axis of said at least one intake port to the general longitudinal axis of the base of is about 90 degrees near the at least one opening for receiving said at least one container.

5. An apparatus as described in claim 1 further comprising:
a a splash resistant device supported within said at least one intake port; and
b a guide disposed within said at least one intake port for receiving and supporting a removable fluid dispensing apparatus.

6. The apparatus of claim 5 wherein said splash resistant device further comprises a gasket having at least one vent opening in said gasket.

7. The apparatus of claim 6 wherein said splash resistant device further comprises a gasket having a plurality of flanges disposed inwardly of the surface of said gasket.

8. The apparatus of claim 1 wherein said splash resistant device further comprises a gasket having a plurality of flanges disposed inwardly of the surface of said gasket and at least one hole disposed in said gasket.

7. The apparatus of claim 5 wherein said guide further comprises:
a. a ridge for engaging said intake port and supporting said gasket;
b. a body supporting said ridge; and
c. a chamber attached to the bottom of the body, having a plurality of openings communicating with said at least one cavity.

8. The apparatus of claim 5, wherein said guide is a funnel which supports said splash resistant device within said intake port.

9. The apparatus of claim 1 further comprising:
a. a chamber at the bottom of the funnel comprising a plurality of struts which releaseably engage the fluid dispensing apparatus.

10. The apparatus of claim 9 wherein said chamber further comprises:
a. a first section having a hole attached to the bottom of said body;
b. a plurality of struts spaced apart from one another attached at one end to said first section; and
c. the opposite ends of said struts being attached to a second section.

11. The apparatus of claim 1 wherein the second section has at least one hole which communicates with the at least one cavity.

12. The apparatus of claim 10 wherein the second section is a closed disk.

13. An apparatus for fluids comprising:
a. an adaptor having a hollow cavity receiving a fluid container;
b. said adaptor having an intake port for receiving fluid from a fluid dispensing apparatus and communicating said fluid to said fluid container.
c. a funnel supported within said intake port; having a chamber which extends into said hollow cavity in said adaptor;
d. said funnel having at least one securing gasket for receiving said fluid dispensing apparatus;
e. a fluid extraction tube for permitting fluid to be selectively removed from said container mounted to said adaptor, said extraction tube having a selectively open and closed end; and
f. a cap for attachment to said intake port and securing said funnel and said gasket to said bottle port.

14. An apparatus as set forth in claim 13 further comprising:
A baffle disposed in the chamber of said funnel and resisting fluid splashing.

15. An apparatus for holding fluids comprising:
a. A funnel mounted in said apparatus having a chamber with a plurality of openings at one end and an opening at the other for receiving fluid; and
b. at least one baffle covering at least a portion of said chamber openings.

16. An apparatus for holding fluids as described in claim 1 wherein said baffle is integral with said chamber.

17. An apparatus for holding fluids as described in claim 15 further comprising:
a. an adaptor having a hollow cavity therein;
b. said adaptor receiving an intake tube having a notch;
c. said intake tube having an intake port communicating with said cavity;
d. a funnel having a plurality of openings disposed within said intake port and a tab which engages said intake tube notch; and
e. a baffle attached to said funnel which partially blocks at least one of said openings

18. An apparatus for holding fluids comprising:
a. a container;
b. a hollow elongated base for attachment to said container at one end and for dispensing fluids from the opposite end of said base;
c. an intake tube mounted on said base having an opening which is disposed at an angle from the longitudinal axis of said base for receiving fluid from a fluid dispensing apparatus and communicating with said container through said base;
d. a fluid extraction apparatus, for selective removal of fluid from said bottle, comprising at least one flexible straw having a first end communicating with the fluid received by said bottle which straw is selectively open and closed at a second end; and
e. a cap for attachment to said bottle opening and securing said funnel and said gasket to said bottle.

19. An apparatus for receiving fluid comprising:
a. a base for receiving a container having at least one cavity
b. at least one intake port supported by said base at an angle from the longitudinal axis of said base for receiving a fluid dispensing apparatus communicating with said at least one cavity of said container;
c. a splash resistant device supported within said at least one intake port; and
d. a guide disposed within said at least one intake port for receiving and supporting a removable fluid dispensing apparatus.
